(19) United States
(12) Patent Application Publication
(10) Pub. No.: US 2026/0106532 A1
(43) Pub. Date: Apr. 16, 2026

(54) POWER MANAGEMENT DEVICE AND METHOD FOR POWER CONVERSION

(71) Applicant: COMPAL ELECTRONICS, INC., Taipei City (TW)

(72) Inventor: Ho-Nien Yu, Taipei City (TW)

(73) Assignee: COMPAL ELECTRONICS, INC., Taipei City (TW)

(21) Appl. No.: 18/981,646

(22) Filed: Dec. 16, 2024

(30) Foreign Application Priority Data
Oct. 14, 2024 (TW) 113138965

(51) Int. Cl. H02M 1/00; H02J 9/00; H02M 1/36

(52) U.S. Cl. CPC H02M 1/0067; H02J 9/005; H02M 1/36

(57) ABSTRACT

A power management device and a method for power conversion are provided. The power management device includes a buck circuit, a boost circuit, and a first and a second O-ring diode circuits. The buck circuit adjusts an input voltage to a first voltage. An embedded controller is activated and powered based on the first voltage. The boost circuit adjusts the first voltage to a second voltage. A system device is activated and powered based on the second voltage. The activated system device provides a first and second alternative power source on the first and second alternative power paths. After the system device is activated, the first and second O-ring diode circuits supply the first and second alternative power sources to the embedded controller and system device, respectively. The buck circuit and the boost circuit are turned off after the system device is activated and a predetermined delay time has passed.

### CROSS-REFERENCE TO RELATED APPLICATION

This application claims the priority benefit of Taiwan application serial no. 113138965, filed on Oct. 14, 2024. The entirety of the above-mentioned patent application is hereby incorporated by reference herein and made a part of this specification.

### BACKGROUND

### Technical Field

The disclosure relates to a power supply and power conversion technology, and in particular relates to a power management device and a method for power conversion.

### Description of Related Art

An electronic device may obtain the required electrical power through a power supply device, or store the electrical power in an electric energy storage device (e.g., a battery) configured within the electronic device. Current consumer electronic devices often use the universal serial bus (USB) interface as the power source, so the USB interfaces of these consumer electronic devices comply with the USB power delivery (PD) charging protocol.

Based on technological advancements, energy efficiency regulations have become more stringent regarding the overall system power consumption of consumer electronic devices during standby or shutdown. For example, the Lot6 SPEC of the EU energy efficiency directive standard stipulates that the power consumption of electrical equipment during shutdown must be less than 237 mW. However, if a buck converter and a boost converter are used to implement the power conversion device, the overall power consumption of these two converters in standby is relatively high, and thus may not meet the aforementioned energy efficiency regulations.

### SUMMARY

A power management device and a method for power conversion, which may reduce the overall power consumption during standby, are provided in the disclosure.

The power management device of the embodiment of the disclosure includes a buck circuit, a boost circuit, a first O-ring diode circuit, and a second O-ring diode circuit. The buck circuit is coupled to an input power source. The buck circuit is configured to adjust an input voltage provided by the input power source to a first voltage, in which an embedded controller is activated and powered based on the first voltage. The boost circuit is coupled to the buck circuit. The boost circuit is configured to obtain the first voltage and adjust the first voltage to a second voltage. The first O-ring diode circuit is coupled to the buck circuit, a first alternative power path, and the embedded controller. The second O-ring diode circuit is coupled to the boost circuit, a second alternative power path, and a system device. The system device is activated and powered based on the second voltage, the activated system device provides a first alternative power source on the first alternative power path, and provides a second alternative power source on the second alternative power path. After the system device is activated, the first O-ring diode circuit supplies the first alternative power source to the embedded controller, and the second O-ring diode circuit supplies the second alternative power source to the system device. The buck circuit and the boost circuit are turned off after the system device is activated and a predetermined delay time has passed.

The method includes the following operation. An input voltage provided by an input power source is adjusted to a first voltage through the buck circuit, in which an embedded controller is activated and powered based on the first voltage. The first voltage is adjusted to a second voltage through the boost circuit, a system device is activated and powered based on the second voltage, and the activated system device provides a first alternative power source and a second alternative power source. After the system device is activated, the first alternative power source is supplied to the embedded controller through a first O-ring diode circuit, the second alternative power source is supplied to the system device through a second O-ring diode circuit. The buck circuit and the boost circuit are turned off after the system device is activated and a predetermined delay time has passed.

Based on the above, in the power management device and the method for power conversion according to the embodiment of the disclosure, when the electronic system is activated, the embedded controller and the system device are activated and powered through the buck circuit and the boost circuit, and the activated system device generates alternative power source through corresponding components (e.g., the charging chip in the alternative power supply device), so that the alternative power source respectively maintains the power supply of the buck circuit and the boost circuit through two O-ring diode circuits. Moreover, after the embedded controller and the system device are activated and operate normally, the buck circuit and the boost circuit are turned off after a predetermined delay time has passed to save power consumption of the buck circuit and the boost circuit.

### BRIEF DESCRIPTION OF THE DRAWINGS

FIG. 1 is a schematic diagram of a power management device and a system device according to an embodiment of the disclosure.

FIG. 2 is a detailed schematic diagram of a power management device and a system device according to an embodiment of the disclosure.

FIG. 3 is a schematic diagram of each voltage in FIG. 2.

FIG. 4 is a flowchart of a method for power conversion according to an embodiment of the disclosure.

### DETAILED DESCRIPTION OF DISCLOSED EMBODIMENTS

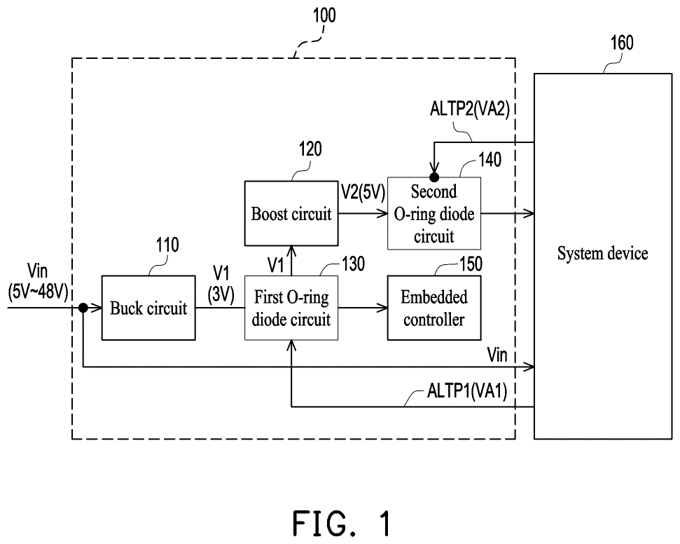

FIG. 1 is a schematic diagram of a power management device 100 and a system device 160 according to an embodiment of the disclosure. The power management device 100 of this embodiment is disposed in an electronic system (e.g., a consumer electronic device, a smartphone, a tablet, a laptop, etc.). The power management device 100 is configured to activate and provide power to the embedded controller 150 and the system device 160.

The power management device 100 includes a buck circuit 110, a boost circuit 120, a first O-ring diode circuit 130, and a second O-ring diode circuit 140. The buck circuit 110 is coupled to an input power source. The buck circuit 110 adjusts the input voltage Vin provided by the input power source to the first voltage V1. The power management device 100 of this embodiment complies with the universal serial bus (USB) power delivery (PD) 3.1 charging protocol, so the voltage of the input voltage Vin ranges between 5V and 48V. The embedded controller 150 obtains the first voltage V1 through the first O-ring diode circuit 130 to be activated and powered based on the first voltage V1. The voltage value of the first voltage V1 in this embodiment is, for example, 3V.

The boost circuit 120 is coupled to the buck circuit 110. The boost circuit 120 of this embodiment is coupled to the buck circuit 110 through the first O-ring diode circuit 130. The buck circuit 110 provides the first voltage V1 to the boost circuit 120 through the first O-ring diode circuit 130. In other embodiments, the boost circuit 120 may also be directly coupled to the buck circuit 110 and obtain the first voltage V1 from the buck circuit 110.

The boost circuit 120 obtains the first voltage V1 and adjusts the first voltage V1 to the second voltage V2. The voltage value of the second voltage V2 in this embodiment is, for example, 5V. The first O-ring diode circuit 130 is coupled to the buck circuit 110, the boost circuit 120, the first alternative power path ALTP1, and the embedded controller 150. The second O-ring diode circuit 140 is coupled to the boost circuit 120, the second alternative power path ALTP2, and the system device 160.

The system device 160 is activated and powered based on the second voltage V2. The activated system device 160 provides a first alternative power source VA1 on the first alternative power path ALTP1, and provides a second alternative power source VA2 on the second alternative power path ALTP2.

After activating the system device 160, the first O-ring diode circuit 130 simultaneously receives the first voltage V1 and the first alternative power source VA1, and the second O-ring diode circuit 140 simultaneously receives the second voltage V2 and the second alternative power source VA2. The O-ring diode circuit in this embodiment may be composed of two independent diodes. The anode terminals of the two diodes respectively serve as two input terminals of the O-ring diode circuit and may be configured to independently receive two sets of different input power sources respectively. The cathode terminals of the two diodes serve as the output terminals of the O-ring diode circuit and are connected in parallel. Based on the forward conduction characteristics of the diode, the maximum voltage value among the two sets of input power sources received by the two anode input terminals is used to provide power to the cathode output terminal of the O-ring diode circuit. Therefore, after activating the system device 160, the first O-ring diode circuit 130 supplies the first alternative power source VA1 to the embedded controller 150, and the second O-ring diode circuit 140 supplies the second alternative power source VA2 to the system device 160. In addition, the buck circuit 110 and the boost circuit 120 will be turned off at a time point after the system device 160 is activated and a predetermined delay time has passed.

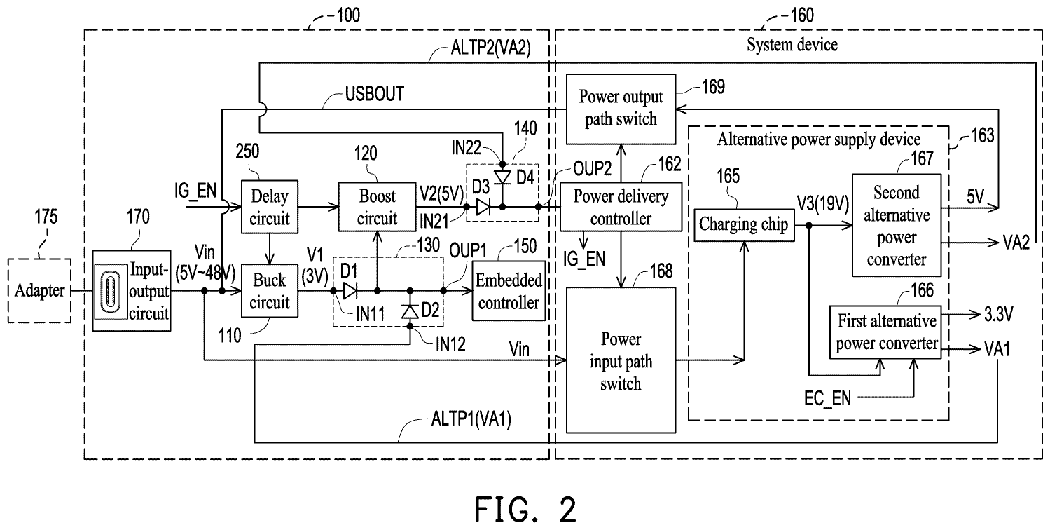

FIG. 2 is a detailed schematic diagram of a power management device 100 and a system device 160 according to an embodiment of the disclosure. The first O-ring diode circuit 130 includes diodes D1 and D2. The anode terminal of the diode D1 is coupled to the buck circuit 110 and serves as the first input terminal IN11 of the first O-ring diode circuit 130. The anode terminal of the diode D2 is coupled to one terminal of the first alternative power path ALTP1 to serve as the second input terminal IN12 of the first O-ring diode circuit 130. The cathode terminal of the diode D1 is coupled to the cathode terminal of the diode D2 and serves as the output terminal OUP1 of the first O-ring diode circuit 130.

When the buck circuit 110 provides the first voltage V1 to the first input terminal IN11 of the first O-ring diode circuit 130, the first O-ring diode circuit 130 provides power to the embedded controller 150 based on the first voltage V1 and through the diode D1. When the first alternative power source VA1 is provided to the second input terminal IN12 of the first O-ring diode circuit 130 through the first alternative power path ALTP1, the first O-ring diode circuit 130 provides power to the embedded controller 150 based on the maximum voltage between the first voltage V1 and the first alternative power source VA1.

The second O-ring diode circuit 140 includes diodes D3 and D4. The anode terminal of the diode D3 is coupled to the boost circuit 120 and serves as the first input terminal IN21 of the second O-ring diode circuit 140. The anode terminal of the diode D4 is coupled to one terminal of the second alternative power path ALTP2 to serve as the second input terminal IN22 of the second O-ring diode circuit 140. The cathode terminal of the diode D3 is coupled to the cathode terminal of the diode D4 and serves as the output terminal OUP2 of the second O-ring diode circuit 140.

When the boost circuit 120 provides the second voltage V2 to the first input terminal IN21 of the second O-ring diode circuit 140, the second O-ring diode circuit 140 activates and provides power to the system device 160 based on the second voltage V2 and through the diode D3. When the second alternative power source VA2 is provided to the second input terminal IN22 of the second O-ring diode circuit 140 through the second alternative power path ALTP2, the second O-ring diode circuit 140 provides power to the system device 160 based on the maximum voltage between the second voltage V2 and the second alternative power source VA2.

The system device 160 of FIG. 2 includes a power delivery (PD) controller 162, a power input path switch 168 and an alternative power supply device 163. The power delivery controller 162 is coupled to the output terminal OUP2 of the second O-ring diode circuit 140. The power delivery controller 162 obtains the second voltage V2 through the second O-ring diode circuit 140, and is activated and powered based on the second voltage V2. The power input path switch 168 is coupled to and controlled by the power delivery controller 162.

The first terminal of the power input path switch 168 receives the input voltage Vin, and the second terminal of the power input path switch 168 is coupled to the alternative power supply device 163. When both terminals of the power input path switch 168 are conducted, the alternative power supply device 163 provides the first alternative power source VA1 on the first alternative power path ALTP1, and provides a second alternative power source VA2 on the second alternative power path ALTP2 based on the input voltage Vin.

The alternative power supply device 163 includes a charging chip 165, a first alternative power converter 166, and a second alternative power converter 167. The charging chip 165 is coupled to the second terminal of the power input path switch 168. The charging chip 165 converts the input voltage Vin into a third voltage V3 with a fixed voltage value (e.g., 19V). The first alternative power converter 166 is coupled between the charging chip 165 and the first alternative power path ALTP1. The first alternative power converter 166 converts the third voltage V3 to the first alternative power source VA1 (e.g., 3.3V) on the first alternative power path ALTP1. The second alternative power converter 167 is coupled to the charging chip 165 and the second alternative power path ALTP2. The second alternative power converter 167 converts the third voltage V3 to the second alternative power source VA2 (e.g., 5V) on the second alternative power path ALTP2. The second alternative power converter 167 converts the third voltage V3 into a voltage of 5V. The first alternative power converter 166 may be controlled by the activation signal EC_EN generated by the embedded controller 150.

The system device 160 of this embodiment further includes a power output path switch 169. The power output path switch 169 is coupled to and controlled by the power delivery controller 162. When both terminals of the power output path switch 169 are conducted, the power output terminal USBOUT of the universal serial bus port is powered based on the voltage of 5V provided by the second alternative power converter 167.

The power management device 100 of FIG. 2 further includes an input-output circuit 170. The power output terminal USBOUT may be disposed in the input-output circuit 170. The input-output circuit 170 includes at least one universal serial bus port. For example, the user may guide the external power to the power management device 100 through the universal serial bus port and the adapter 175 that is compliant to the universal serial bus, or guide the voltage of 5V provided by the power output terminal USBOUT outside of the power management device 100 to provide power to an external device (not shown).

The power management device 100 of FIG. 2 further includes a delay circuit 250. After the first alternative power converter 166 and the second alternative power converter 167 are activated, based on the activation signal (e.g., the activation signal IG_EN generated by the power delivery controller 162) from the embedded controller 150 or the system device 160, a delayed signal is obtained through a delay circuit 250 after a predetermined delay time has passed for the aforementioned activation signal. Subsequently, based on this delayed signal, the buck circuit 110 and the boost circuit 120 are turned off, thereby conserving power consumption generated by the buck circuit 110 and the boost circuit 120 when the electronic system is on standby. In this embodiment, the delay circuit 250 is, for example, a resistor-capacitor (RC) delay circuit.

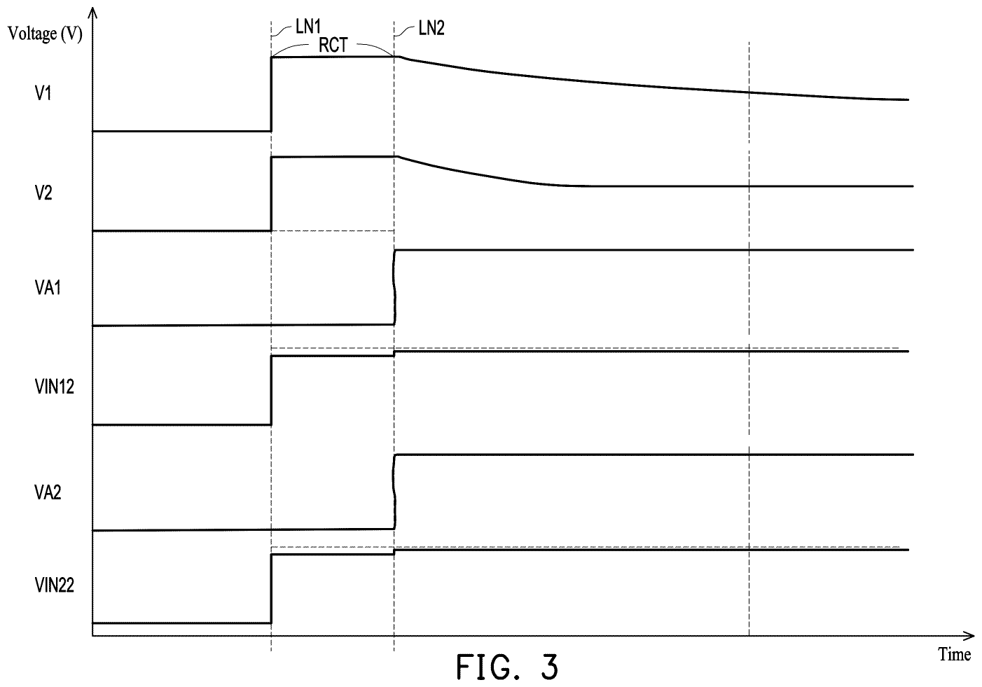

FIG. 3 is a schematic diagram of each voltage in FIG. 2. FIG. 3 shows exemplary waveforms of the first voltage V1, the second voltage V2, the first alternative power source VA1, the second alternative power source VA2, the voltage VIN12 of the output terminal OUP1 in the first O-ring diode circuit 130, and the voltage VIN22 of the output terminal OUP2 in the second O-ring diode circuit 140. Based on FIG. 3, it may be seen that the time point at line LN1 represents the moment when the electronic system receives the input voltage Vin from an external power source. At this time, the first voltage V1 and the second voltage V2 are generated in response to the buck circuit 110 and the boost circuit 120 in FIG. 1 and FIG. 2, thus activating the embedded controller 150 and the system device 160.

The time point at line LN2 in FIG. 3 represents the moment when the system device 160 is activated and the predetermined delay time RCT has passed. The first alternative power source VA1 and the second alternative power source VA2 are generated by the system device 160, and at the time point of line LN2, the voltage values of the first voltage V1 and the second voltage V2 gradually decrease as the buck circuit 110 and the boost circuit 120 in FIG. 1 and FIG. 2 are turned off. The voltage VIN12 and the voltage VIN22 will maintain their voltage values to respectively provide power to the embedded controller 150 and the system device 160.

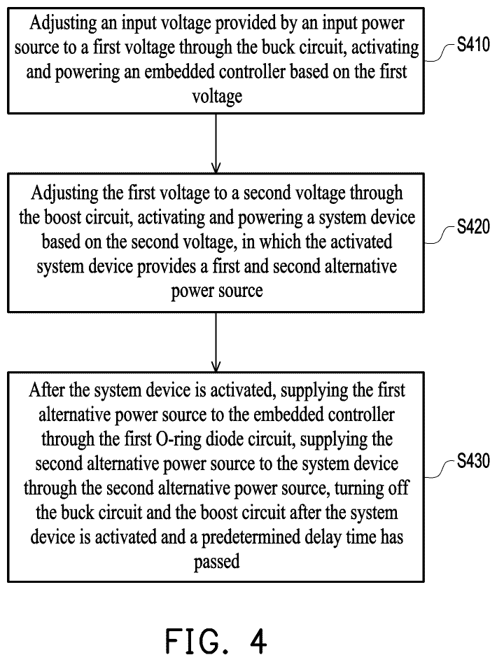

FIG. 4 is a flowchart of a method for power conversion according to an embodiment of the disclosure. The method described in FIG. 4 is applicable to the power management device 100 and the system device 160 of FIG. 1. In step S410, the input voltage Vin provided by the input power source is adjusted to the first voltage V1 through the buck circuit 110. The embedded controller 150 is activated and powered based on the first voltage V1. In step S420, the first voltage V1 is adjusted to the second voltage V2 through the boost circuit 120. The system device 160 is activated and powered based on the second voltage V2. The activated system device 160 provides a first alternative power source VA1 and a second alternative power source VA2. In step S430, after activating the system device 160, the first alternative power source VA1 is supplied to the embedded controller 150 through the first O-ring diode circuit 130, the second alternative power source VA2 is supplied to the system device 160 through the second O-ring diode circuit 140, and the buck circuit 110 and the boost circuit 120 are turned off after the system device 160 is activated and a predetermined delay time has passed. For details of each step in the method described in FIG. 4, reference may be made to the aforementioned embodiments.

In the power management device and the method for power conversion according to the embodiment of the disclosure, when the electronic system is activated, the embedded controller and the system device are activated and powered through the buck circuit and the boost circuit, and the activated system device generates alternative power source through corresponding components (e.g., the charging chip in the alternative power supply device), so that the alternative power source respectively maintains the power supply of the buck circuit and the boost circuit through two O-ring diode circuits. Moreover, after the embedded controller and the system device are activated and operate normally, the buck circuit and the boost circuit are turned off after a predetermined delay time has passed to save power consumption of the buck circuit and the boost circuit.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

What is claimed is:

1. A power management device, comprising:
a buck circuit, coupled to an input power source, configured to adjust an input voltage provided by the input power source to a first voltage, wherein an embedded controller is activated and powered based on the first voltage;
a boost circuit, coupled to the buck circuit, configured to obtain the first voltage and adjust the first voltage to a second voltage;
a first O-ring diode circuit, coupled to the buck circuit, a first alternative power path, and the embedded controller; and
a second O-ring diode circuit, coupled to the boost circuit, a second alternative power path, and a system device,
wherein the system device is activated and powered based on the second voltage, the system device that is activated provides a first alternative power source on the first alternative power path, and provides a second alternative power source on the second alternative power path,
wherein, after the system device is activated, the first O-ring diode circuit supplies the first alternative power source to the embedded controller, the second O-ring diode circuit supplies the second alternative power source to the system device, and the buck circuit and the boost circuit are turned off after the system device is activated and a predetermined delay time has passed.

2. The power management device according to claim 1, wherein the first O-ring diode circuit comprises:
a first diode, an anode terminal thereof coupling to the buck circuit to serve as a first input terminal of the first O-ring diode circuit; and
a second diode, an anode terminal thereof coupling to one terminal of the first alternative power path to serve as a second input terminal of the first O-ring diode circuit, wherein a cathode terminal of the first diode is coupled to a cathode terminal of the second diode and serves as an output terminal of the first O-ring diode circuit,
wherein, when the buck circuit provides the first voltage to the first input terminal of the first O-ring diode circuit, the first O-ring diode circuit provides power to the embedded controller based on the first voltage,
when the first alternative power source is provided to the second input terminal of the first O-ring diode circuit through the first alternative power path, the first O-ring diode circuit provides power to the embedded controller based on a maximum voltage between the first voltage and the first alternative power source.

3. The power management device according to claim 1, wherein the buck circuit provides the first voltage to the boost circuit through the first O-ring diode circuit.

4. The power management device according to claim 1, wherein the second O-ring diode circuit comprises:
a third diode, an anode terminal thereof coupling to the boost circuit to serve as a first input terminal of the second O-ring diode circuit; and
a fourth diode, an anode terminal thereof coupling to one terminal of the second alternative power path to serve as a second input terminal of the second O-ring diode circuit, wherein a cathode terminal of the third diode is coupled to a cathode terminal of the fourth diode and serves as an output terminal of the second O-ring diode circuit,
wherein, when the boost circuit provides the second voltage to the first input terminal of the second O-ring diode circuit, the second O-ring diode circuit activates and provides power to the system device based on the second voltage,
when the second alternative power source is provided to the second input terminal of the second O-ring diode circuit through the second alternative power path, the second O-ring diode circuit provides power to the system device based on a maximum voltage between the second voltage and the second alternative power source.

5. The power management device according to claim 1, wherein the system device comprises:
a power delivery controller, coupled to an output terminal of the second O-ring diode circuit, configured to obtain the second voltage through the second O-ring diode circuit, and activated and powered based on the second voltage;
a power input path switch, coupled to and controlled by the power delivery controller, wherein a first terminal of the power input path switch receives the input voltage; and
an alternative power supply device, coupled to a second terminal of the power input path switch, wherein when both terminals of the power input path switch are conducted, a first alternative power source is provided on the first alternative power path and a second alternative power source is provided on the second alternative power path based on the input voltage.

6. The power management device according to claim 5, wherein the alternative power supply device comprises:
a charging chip, coupled to the second terminal of the power input path switch, configured to convert the input voltage into a third voltage;
a first alternative power converter, coupled to the charging chip and the first alternative power path, configured to convert the third voltage into the first alternative power source on the first alternative power path; and
a second alternative power converter, coupled to the charging chip and the second alternative power path, configured to convert the third voltage into the second alternative power source on the second alternative power path.

7. The power management device according to claim 5, wherein the system device further comprises:
a power output path switch, coupled to and controlled by the power delivery controller,
wherein, when the power output path switch is conducted, power is provided to a power output terminal of a universal serial bus port based on the second alternative power source.

8. The power management device according to claim 1, further comprising:
a delay circuit, coupled to the boost circuit and the buck circuit,
wherein, the boost circuit and the buck circuit are set to be turned off through the delay circuit after the power delivery controller is activated and the predetermined delay time has passed.

9. A method for power conversion, suitable for a power management device comprising a buck circuit and a boost circuit, the method comprising:
adjusting an input voltage provided by an input power source to a first voltage through the buck circuit, wherein an embedded controller is activated and powered based on the first voltage;
adjusting the first voltage to a second voltage through the boost circuit, wherein a system device is activated and powered based on the second voltage, the system device that is activated provides a first alternative power source and a second alternative power source; and
supplying the first alternative power source to the embedded controller through a first O-ring diode circuit and supplying the second alternative power source to the system device through a second O-ring diode circuit after the system device is activated, turning off the buck circuit and the boost circuit after the system device is activated and a predetermined delay time has passed.
